(19) United States
(12) Patent Application Publication
(10) Pub. No.: US 2008/0131703 A1
(43) Pub. Date: Jun. 5, 2008

(54) Non-Stick Coating with Improved Resistance to Scratching and Culinary Article Provided with Said Coating

(76) Inventors: J. P. Buffard, Tresserve (FR); Claudine Gardaz, Bloye (FR); Laurent Voisin, Sales (FR)

Correspondence Address: BACHMAN & LAPOINTE, P.C., 900 CHAPEL STREET, SUITE 1201, NEW HAVEN, CT, 06510, US

(21) Appl. No.: 11/628,384

(22) PCT Filed: May 31, 2005
(86) PCT No.: PCT/FR05/01334

§ 371 Date: Aug. 22, 2007

(30) Foreign Application Priority Data
Jun. 2, 2004 (FR) 04 05964

(51) Int. Cl. B32B 27/00

(52) U.S. Cl. 428/421

(57) ABSTRACT

The invention relates to a non-stick coating with improved resistance to scratching, comprising at least one first base coat applied to a support and covered by one or several top coats based on Fluorocarbon resin. The base coat comprises the following expressed as a percentage of dry matter measured in relation to the overall composition: 9-15% by weight fluorocarbon resin, 4-5% by weight polyamide imide resin (PAI), 12-1.1% by weight polyetherethercetone (PEEK), the remainder consisting of technological additives, inert charges and dispersive media. The invention also relates to a culinary item provided with the coating.

### BACKGROUND OF THE INVENTION

(1) Field of the Invention

The present invention relates to a non-stick coating with improved scratch resistance.

(2) Prior Art

The non-stick coatings commonly used to coat cookware are obtained from fluorocarbon resin-based compositions, for example compositions containing polytetrafluoroethylene (PTFE), applied to a metal substrate.

However, such PTFE-based coatings, known for their non-stick properties as well as for their chemical and heat resistance, exhibit the disadvantage of being particularly sensitive to scratching. Additionally, repeated use causes the non-stick properties of such coatings to diminish and leads to the premature wear of cookware equipped with these types of coatings.

Various techniques have been developed to remedy this major disadvantage and to obtain non-stick coatings with improved scratch resistance.

A widely used technique consists of applying a so-called “hard” undercoat directly to the metal substrate before the application of at least one fluorocarbon-resin based primary coat and one or more fluorocarbon-resin based outer coats. This “hard” undercoat forms a barrier that prevents scratches from reaching the metal substrate.

Various types of undercoats have thus been used, among which undercoats constituted by alumina, enamel, stainless steel or polyamide-imide (PAI) resin can be cited.

More recently, documents EP 1 169 141 and EP 1 169 142 each have disclosed an undercoat made from polyetheretherketone (PEEK).

The composition of the undercoat disclosed in document EP 1 169 141 is, after curing, exclusively constituted by PEEK.

The composition of the undercoat disclosed in document EP 1 169 142 comprises at least 50% by weight of PEEK, the remainder being constituted by thermostable polymers, pure or in mixtures, such as polyphenylene sulfide (PPS), polyetherimide (PEI), polyimide, polyetherketone (PEK), polyethersulfone (PES) or polyamide-imide (PAI) and by inert fillers such as metal oxides, silica, mica particles or lamellar fillers.

Quite satisfactory results in terms of scratch resistance are obtained with non-stick coatings comprising the application of an undercoat made exclusively or primarily of PEEK.

However, the application of any undercoat has an appreciable effect on the manufacturing process and cost of items equipped with non-stick coatings.

Indeed, this involves an additional application which is interposed between the metal substrate and the primary coat or coats. Thus, this constitutes an additional step which can require, moreover, additional raw materials or industrial equipment.

Depending on the nature of the undercoat, it may be necessary to resort to application techniques other than those commonly used for the application of fluorocarbon resin-based coats, said common techniques being spraying, roll coating, screen printing and pad printing.

In the specific case where the undercoat is made exclusively or primarily of PEEK, manufacturing cost is also clearly higher since PEEK is a particularly expensive resin.

The problem presented is thus to create a non-stick coating which exhibits very good performance with respect to scratch resistance, which maintains its non-stick properties over time and which remedies all of the disadvantages mentioned above related to the application of the manufacturing process, the choice of raw materials used and the economic effects generated thereby.

### SUMMARY OF THE INVENTION

A solution to the problem presented is a non-stick coating comprising at least one first primary coat applied to a metal substrate and coated by one or more fluorocarbon resin-based outer coats.

The creation of such a coating, using direct application of at least one primary coat to the substrate, in the absence of any preliminary undercoat application, allows a simplification of the manufacturing process as well as an economy of materials, the latter being enhanced in addition by the use of less-expensive raw materials, as will be seen below.

According to the invention, the first primary coat comprises, in percentage of dry matter measured for the total composition, from 9% to 15% by weight of a fluorocarbon resin, from 4% to 5% by weight of a polyamide-imide (PAI) resin, from 0.12% to 1.1% by weight of a polyetheretherketone (PEEK) resin, the remainder comprising technological additives, inert fillers such as pigments and dispersing media.

The applicant has noted, surprisingly and unexpectedly, that the incorporation of a very small quantity of PEEK, included in a given interval of selected weight percentages, in the composition of a first primary coat makes it possible to obtain a final non-stick coating with excellent scratch resistance, contrary to the prior art which recommends the use of an undercoat comprising at least 50% by weight of PEEK.

Tests have indeed shown that weight contents of PEEK less than or equal to 0.06% by weight make it impossible to achieve satisfactory results.

Similarly, it has been observed that weight contents of PEEK greater than or equal to 1.2% by weight also make it impossible to achieve good results.

The present invention also relates to a culinary article coated by a non-stick coating as described above which will be described in detail further below in the description.

### DETAILED DESCRIPTION OF THE PREFERRED EMBODIMENT(S)

The non-stick coating in conformity with the invention can be applied to any metal substrate that is resistant to temperatures above 400° C. This metal substrate can, for example, be of aluminum, aluminum alloy, stainless steel or titanium.

After degreasing, this substrate can be left smooth or rendered slightly rough, notably by sandblasting.

To this metal substrate, is applied a first primary coat in conformity with the invention, comprising, in percentage of dry matter measured for the total composition of the aforesaid first primary coat, from 9% to 15% by weight of a fluorocarbon resin, from 4% to 5% by weight of a polyamide-imide (PAI) resin, from 0.12% to 1.1% by weight of PEEK, the remainder being comprising technological additives, inert fillers such as pigments and dispersing media.

The weight contents mentioned above correspond to the respective quantities of fluorocarbon, PAI and PEEK resins in the form of pure products, under the assumption that each will be introduced into the composition of the first primary coat at 100% dry extract.

In practice, the majority of the aforesaid resins are more generally used in dispersion form, for example an aqueous dispersion.

Thus, a specific composition A of the first primary coat in conformity with the invention is as follows:

| | |
|---|---|
| aqueous PTFE dispersion | from 15% to 25% |
| (60% dry extract) | |
| aqueous PAI dispersion | from 40% to 55% |
| (10% dry extract) | |
| PEEK (pure product) | from 0.12% to 1.10% |
| aqueous colloidal silica dispersion | from 15% to 25% |
| (30% dry extract) | |
| aqueous carbon black dispersion | from 3.0% to 4.5% |
| (20% dry extract) | |
| technological additives | from 10% to 24% |
| dispersing media | from 54% to 80%. |

A polyetheretherketone (PEEK) resin with a suitable grain size, one which does not lead to the formation of a rough first primary coat, preferably will be used. PEEK grain size between 5 μm and 35 μm is more particularly preferred.

In addition to the fluorocarbon, PAI and PEEK resins, the composition of the first primary coat indicated above is constituted by an adhesive agent which is, in the case in point, colloidal silica, as well as a pigment, carbon black.

In addition, the composition of the first primary coat comprises technological additives as well as dispersing media which, together, make it possible to adapt the formulation of the composition to its mode of application.

The dispersing media commonly used are aqueous media, as for example a base and/or water, or organic solvents, or even mixtures of aqueous media and organic solvents.

Nothing prohibits the consideration of adding, to the composition of the first primary coat indicated above, other compounds such as fillers and/or pigments, in addition to the carbon black dispersion already mentioned.

The first primary coat can be applied by any conventional process commonly employed for the application of fluorocarbon resin-based coats.

In an advantageous embodiment of the invention, a spray application, which in the end provides a first continuous primary coat that does not present any surface defects, will be used.

It is specified that all compositions of the first primary coat described in the present description are suitable for the aforementioned spray application.

For questions of economy of materials, application by screen printing can also be used, subject to the adaptation of the composition of the first primary coat to said mode of application by the addition of specific technological additives.

Such technological additives for application by screen printing can comprise one or more of the following compounds: a solvent, a thickening agent and/or a gelling agent as well as an antifoaming agent that makes it possible to obtain a smooth and homogeneous coat.

In particular, the examples of solvents and of gelling and/or thickening agents disclosed in document EP 0 188 958 may be consulted.

The antifoaming agent is selected among mineral oils or silicones, for example.

Typically, the thickness of the first primary coat is between 4 μm and 12 μm, preferably between 4 μm and 8 μm.

After the application and drying of the first primary coat, at least one fluorocarbon resin-based outer coat can then be applied.

However, for reasons of cohesion, the non-stick coating according to the invention contains a second primary coat that is applied to the first primary coat prior to the application of the fluorocarbon resin-based outer coats.

According to an advantageous embodiment of the invention, this second primary coat comprises a fluorocarbon resin and a polyamide-imide (PAI) resin.

The second primary coat can include, in addition, a polyetheretherketone (PEEK) resin.

First and second primary coats of identical composition can certainly be envisaged.

However, to optimize adhesion between the various coats, and more particularly adhesion of the first primary coat to the first outer coat which is then applied, it is preferable to apply a second primary coat not containing polyetheretherketone (PEEK) resin to the first primary coat prior to the application of the first outer coat.

According to an advantageous embodiment of the invention, the second primary coat has the following composition, with the weight contents of the resins, as was the case for the composition of the first primary coat above, being expressed in percentages of pure product:

| | |
|---|---|
| fluorocarbon resin | from 22% to 30% |
| PAI resin | from 1.5% to 2.0% |
| aqueous colloidal silica dispersion | from 3% to 6% |
| aqueous carbon black dispersion | from 0.6% to 1.0% |
| technological additives | from 12% to 22% |
| dispersing media | from 39% to 58%. |

The compounds likely to be used as technological additives and dispersing media, as well as their respective roles, are of the same nature as those indicated above for the composition of the first primary coat.

A specific composition B of the second primary coat lacking PEEK and prepared from an aqueous dispersion of resins can be as follows:

| | |
|---|---|
| aqueous PTFE dispersion | from 30% to 40% |
| (60% dry extract) | |
| aqueous PFA dispersion | from 8% to 12% |
| (50% dry extract) | |
| aqueous PAI dispersion | from 15% to 20% |
| (10% dry extract) | |
| aqueous colloidal silica dispersion | from 10% to 20% |
| (30% dry extract) | |
| aqueous carbon black dispersion | from 3.0% to 5.0% |
| (20% dry extract) | |
| technological additives | from 12% to 22% |
| dispersing media | from 39% to 58%. |

Another composition of the second primary coat lacking PEEK that makes it possible to create a non-stick coating in conformity with the invention is the composition of the primary coat disclosed in documents EP 1,169,141 and EP 1,169,142.

The second primary coat can also be applied by any conventional process commonly employed for the application of fluorocarbon resin-based coats, in particular by spraying.

Typically, the thickness of the second primary coat is between 4 μm and 12 μm, preferably between 4 μm and 8 μm.

After the application and drying of the second primary coat, at least one fluorocarbon resin-based outer coat can then be applied.

The fluorocarbon resins likely to be suitable for the composition of the first and second primary coats, as well as for the outer coats, are disclosed in the document U.S. Pat. No. 5,536,583 in particular.

Preferably, the fluorocarbon resin of the first primary coat and, when it is present, of the second primary coat, is constituted by at least one compound chosen among polytetrafluoroethylene (PTFE), tetrafluoroethylene-perfluoropropylvinylether copolymer (PFA) or tetrafluoroethylene-hexafluoropropylene copolymer (FEP).

In an advantageous embodiment of the invention, two outer coats will be applied, first an intermediate outer coat then an uppermost outer coat.

Nothing prohibits the application of only one outer coat or more than two outer coats.

Examples of compositions of intermediate and uppermost outer coats likely to be used within the framework of the non-stick coating of the present invention are as follows:

Composition C for the intermediate outer coat

| | |
|---|---|
| aqueous PTFE dispersion | from 70% to 85% |
| (60% dry extract) | |
| aqueous PFA dispersion | from 0.1% to 1.0% |
| (50% dry extract) | |
| aqueous carbon black dispersion | from 0.01% to 0.05% |
| (20% dry extract) | |
| technological additives + dispersing media | from 11% to 28% |
| TiO₂-coated mica flakes | from 0.1% to 0.4%. |

Composition D for the uppermost outer coat

| | |
|---|---|
| aqueous PTFE dispersion | from 70% to 85% |
| (60% dry extract) | |
| technological additives + dispersing media | from 11% to 28% |
| TiO₂-coated mica flakes | from 0.1% to 0.4%. |

Documents EP 1 169 141 and EP 1 169 142 disclose other compositions of intermediate and uppermost outer coats likely to be applied within the framework of the present invention.

After application of these outer coats, the assembly of first and second primary coats and outer coats is sintered, for example at a temperature of 400° C. to 420° C. for 3 to 7 minutes.

The total thickness of the two intermediate and uppermost outer coats is between 12 μm and 25 μm.

It is observed that the non-stick coating obtained adheres perfectly well to the metal substrate.

Tests were then conducted to determine the non-stick properties as well as the scratch resistance of the non-stick coatings in conformity with the invention.

Test 1—Test 1 consists of carrying out intensive food-cooking cycles representing 1 to 2 years of use, either using metal spatulas for turning and cooking food or using a metal whisk to cook food.

Test 1 was carried out on three types of non-stick coatings:
the first containing a “hard” undercoat made exclusively of PEEK, with the first and second primary coats of a composition in conformity with composition B indicated above,
the second containing a PAI-based “hard” undercoat, with the first and second primary coats of a composition also in conformity with composition B, and
the third not containing a “hard” undercoat but rather a first primary coat of a composition in conformity with composition A indicated above and a second primary coat in conformity with composition B.

The intermediate and uppermost outer coats were identical for these three coatings and, respectively, of compositions in conformity with compositions C and D indicated above.

It was observed that the behavior of each of these three non-stick coatings was comparable and quite acceptable with respect to non-stick characteristics.

In addition, the absence of staining on each of these three coatings was noted during test 1.

Test 2—This test consists of determining the scratch resistance of cookware coated with non-stick coatings.

This test uses a device that makes it possible to simulate an attack by a metal utensil, such as a piece of flatware, on the non-stick surface of an item of cookware.

Indeed, this test makes it possible to create wear on the surface of the tested non-stick coating under the action of three stainless steel balls which follow random trajectories on the aforementioned coating under the effect of dual axial rotation.

The ball support axle completes 100 rotations in 2 min 36 sec while the arm that supports the ball axle completes 100 rotations in 8 min 10 sec.

Under the conditions of the test, the temperature of the surface is maintained at a temperature of approximately 180° C. and the weight of the scratching device assembly containing the three balls is 310 g±5 g.

Successive movements and rotations of the balls on the surface of the tested non-stick coating cause scratches, which become more and more visible and significant on the surface of the coating as the test progresses.

These scratches decrease the non-stick performance of the non-stick coating.

The decrease in the non-stick performance of the non-stick coating is measured by the so-called “burned milk” method recorded under French standard NF 21-511.

Non-stick performance is determined by the period of time measured at the end of which the film of burned milk is not completely detached from the cooking surface.

Test 2 was conducted on multiple pans each constituted by an aluminum substrate coated with a non-stick coating in conformity with the invention and constituted by a first primary coat of composition A, a second primary coat of composition B, an intermediate outer coat of composition C and an uppermost outer coat of composition D, with compositions B, C and D being identical in all the non-stick coatings tested and with only the PEEK weight content varying in composition A of the first primary coat.

Measurements of resistance time were carried out after a first scratching cycle of two hours in duration, followed by successive scratching cycles of 15 minutes each.

After each scratching cycle, and after cooling and washing the item of cookware, non-stick performance was measured by means of the so-called “burned milk” method according to French standard NF 21-511.

25 cm³ of milk are poured into the tested pan and then boiled until a film of evenly burned milk covers the entire surface of the bottom of the pan.

The pan is then placed at a 135° angle under a stream of cold water and the behavior of the film of burned milk is observed.

The following results were obtained, with performance being indicated by the total time of the scratching cycles at the end of which the burned milk film is not completely detached from the cooking surface:

| PEEK weight content of | Scratching resistance time |
|---|---|
| composition A (%) | (hh:mm) |
| 0 | 2:30-2:45 |
| 0.06 | 2:30-2:45 |
| 0.12 | 3:45-4:00 |
| 0.3 | 3:15-3:30 |
| 0.48 | 3:15-3:30 |
| 0.6 | 3:15-3:30 |
| 0.78 | 3:45-4:00 |
| 0.9 | 4:00-4:15 |
| 1.2 | 2:30-2:45 |
| 1.44 | 2:30-2:45 |
| 1.68 | (*) |

Thus it is noted that when the first primary coat comprises PEEK in an amount of 0.12% to 1.2% by weight, advantageously 0.12% to 1.0% by weight, and more preferentially from 0.12% to 0.9% by weight, the non-stick character is quite clearly improved, since it deteriorates only after a minimum of 3 h 15 min of testing, or 4 h or even 4 h 15 min.

It is noted in addition that a first primary coat constituted by low weight contents of PEEK, and in particular PEEK contents less than or equal to 0.06% by weight, does not make it possible to improve the scratch resistance time of the non-stick coating, as the non-stick character is lost at the end of 2 h 30 min to 2 h 45 min, as in the case of a composition A lacking PEEK.

Lastly, beyond a PEEK weight content of 1.2%, it is observed that the scratch resistance times clearly decrease, as the non-stick character is lost at the end of a period of time ranging between 2 h 30 min and 2 h 45 min.

It should also be noted that for a 1.68% PEEK content by weight in composition A, the inventors observed that applying composition A was difficult and that the final coating obtained was very rough, thus making this formulation difficult to use (results marked (*) in the table).

Thus, the present invention is clearly a selection invention, namely that a low weight content of PEEK, ranging between 0.12% and 1.1%, in the composition of the first primary coat makes it possible to obtain quite clearly improved scratch resistance at very little extra cost given the small quantities of PEEK required to achieve these excellent results.

Additional tests, comparable in nature to those previously performed, were carried out with small quantities of fillers widely known to strengthen scratch resistance of non-stick coatings in the place of PEEK in composition A of the first primary coat.

Among these fillers, mineral fillers such as pigments, such as sodium silicoaluminate or ultramarine blue pigment, enamel and quartz frit, as well as an organic filler, namely small amounts of polyphenylene sulfide (PPS), were used.

Compositions B, C and D of the second primary coat and the intermediate and uppermost outer coats remained unchanged with respect to the first series of tests performed in test 2.

The following results were obtained:

| Nature of the | | Scratching |
|---|---|---|
| filler in | Weight content of | resistance time |
| composition A | the filler (%) | (hh:mm) |
| Ultramarine blue | 0.5 | 2:45 |
| pigment | | |
| Ultramarine blue | 2.2 | 2:45 |
| pigment | | |
| Sheet steel ground | 0.5 | 2:45 |
| enamel frit (<3 μm) | | |
| Sheet steel ground | 2.0 | 2:45 |
| enamel frit (<3 μm) | | |
| Sheet steel ground | 10.0 | 2:30 |
| enamel frit (<3 μm) | | |
| Quartz | 0.5 | 2:30 |
| PPS | 0.5 | 2:30 |
| PPS | 2.0 | 2:15 |

Thus it is noted that with mineral or organic fillers well known for strengthening fluorocarbon resin-based coating compositions, scratch resistance times achieved within the framework of the present test are at a maximum 2 h 45 min, which is quite lower than those obtained with non-stick coatings constituted by a first primary coat having weight contents of PEEK between 0.12% and 1.1%.

1-9. (canceled)

10. A non-stick coating having improved scratch resistance, comprising a first primary coat applied to a metal substrate and coated by at least one fluorocarbon resin-based outer coat, wherein the first primary coat comprises, in percentage of dry matter measured for the total composition, from 9% to 15% by weight of a fluorocarbon resin, from 4% to 5% by weight of a polyamide-imide (PAI) resin, from 0.12% to 1.1% by weight of a polyetheretherketone (PEEK) resin, and the remainder comprising technological additives, and inert fillers, and dispersing media.

11. A non-stick coating according to claim 10, wherein the first primary coat comprises from 0.12% to 1.0% by weight of a polyetheretherketone (PEEK) resin.

12. A nonstick coating according to claim 10, wherein the first primary coat comprises from 0.12% to 0.9% by weight of a polyetheretherketone (PEEK) resin.

13. A non-stick coating according to claim 10, wherein the polyetheretherketone (PEEK) resin has a grain size between 5 μm and 35 μm.

14. A non-stick coating according to anyone of claim 10, further comprising a second primary coat comprising a fluorocarbon resin and a polyamide-imide (PAI) resin, and the second primary coat being applied to the first primary coat prior to the application of the at least one outer coat.

15. A non-stick coating according to claim 14, wherein the second primary coat additionally comprises a polyetheretherketone (PEEK) resin.

16. A non-stick coating according to claim 15, wherein the first and second primary coats have an identical composition.

17. A non-stick coating according to claim 14, wherein the second primary coat does not contain a polyetheretherketone (PEEK) resin.

18. A non-stick coating according to anyone of claim 10, wherein the fluorocarbon resin of the first primary coat and, when present, of an optional second primary coat, comprises at least one compound selected from the group consisting of polytetrafluoroethylene (PTFE), tetrafluoroethylene-perfluoropropylvinylether copolymer (PFA) or tetrafluoroethylene-hexafluoropropylene copolymer (FEP).

19. A culinary article coated by a non-stick coating according to claim 10.
